(19) United States
(12) Patent Application Publication
(10) Pub. No.: US 2022/0309178 A1
(43) Pub. Date: Sep. 29, 2022

(54) PRIVATE SEARCHABLE DATABASE

(71) Applicant: FUJITSU LIMITED, Kawasaki-shi (JP)

(72) Inventors: Arnab ROY, Santa Clara, CA (US); Hart MONTGOMERY, Redwood City, CA (US); Avradip MANDAL, Sunnyvale, CA (US)

(73) Assignee: FUJITSU LIMITED, Kawasaki-shi (JP)

(21) Appl. No.: 17/210,225

(22) Filed: Mar. 23, 2021

(51) Int. Cl. G06F 21/62; G06F 21/60; G06F 16/245

(52) U.S. Cl. CPC G06F 21/6227; G06F 21/602; G06F 16/245

(57) ABSTRACT

A method may include receiving a set of encrypted data and an associated public parameter from a first device. The set of encrypted data may be organized in rows. The method may also include receiving an encrypted query of an underlying query from a second device. The method may also include determining a query result using the set of encrypted data, the associated public parameter, and the encrypted query. The query result may include responsive rows of the set of encrypted data that remain encrypted. The responsive rows may be responsive to the underlying query without exposing the underlying query or the set of encrypted data to the system. The method may also include sending the query result to the second device.

The embodiments discussed in the present disclosure are related to a private searchable database.

### BACKGROUND

Databases provide organized collections of data. The data located in a database may be queried to provide relevant segments of information to the requestor. Some data located in a database may be private or confidential and it may be desirable to maintain tight security and control over the more sensitive data.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

In an example embodiment, a method may include receiving, by a system, a first set of encrypted data and an associated public parameter from a first device, where the first set of encrypted data may be organized in rows. The method may also include receiving a first encrypted query of an underlying query from a second device. The method may also include determining a query result using the first set of encrypted data, the associated public parameter, and the first encrypted query. The query result may include responsive rows of the first set of encrypted data, and the responsive rows may remain encrypted and may be responsive to the underlying query without exposing the underlying query to the system. The method may also include sending the query result to the second device.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates a block diagram of an example operating environment that includes a private searchable database;

FIG. 2 illustrates an example operational flow associated with a private searchable database;

FIG. 3 illustrates a flowchart of an example method of a private searchable database with multiple queries;

FIG. 4 illustrates a flowchart of an example method of limiting queries to devices with permissions;

FIG. 5 illustrates a flowchart of an example method of building a query result responsive to a query;

FIG. 6 illustrates a flowchart of an example method of generating and distributing security measures for private data;

FIG. 7 illustrates a flowchart of a device receiving encryption data and permissions to query a private database and receive a query result; and

FIG. 8 illustrates an example computing system.

### DESCRIPTION OF EMBODIMENTS

Databases provide an organized structure to store various forms and amounts of data. For example, some databases may contain inventory items and quantities for a given business. Due to the organized structure of databases, it may be possible to request data contained therein, or information related to the data, using queries. Queries may be plain text requests submitted to a database configured to generate responsive data from the database. In some circumstances, databases may contain sensitive and/or private data. For example, a hospital may include a database that contains patient records and other sensitive medical information. For example, a main business function of a hospital is providing medical services, not hosting data storage. In some circumstances, it may be beneficial to the hospital to store data on a remote device, such as a cloud-based storage service. However, as hospital data may include sensitive and/or private data, it may be desirable to maintain privacy on data that is stored in such a cloud-based storage service.

In accordance with one or more embodiments of the present disclosure, a database may be stored in an encrypted form on a storage system remote from the device providing and/or querying the database, where the database is encrypted in a manner that data in the database is not exposed to the storage system even when queried. For example, a device (such as a hospital server) may encrypt a set of data (such as patient records) using an inner product function-private functional encryption scheme. When querying the database (whether by the hospital or some third party granted access to the data), a master secret key used in encrypting the database may be used to encrypt an underlying query. The resulting encrypted query may be sent to the storage system. The storage system may use the encrypted query and a public key generated when encrypting the data to identify responsive rows of the database without data of the rows being exposed. The responsive rows may be provided to the querying device, still in their encrypted form.

In some circumstances, embodiments of the present disclosure may facilitate improved security and privacy for computing devices, including for data stored in a database by maintaining an encryption scheme on the data. For example, sensitive data, such as hospital patient records, may be encrypted and sent to a data storage system for storage, such that the data storage system is unable to access the contents of the encrypted data while still permitting queries to the database while remaining in an encrypted form. In addition, embodiments of the present disclosure may facilitate improved security and privacy for queries requesting data from the database by maintaining an encryption scheme on the query. For example, a hospital may authorize a research group to access patient records stored at a storage system. The research group may submit an encrypted query to the storage system, such that the data storage system is unable to access the contents of the encrypted query. In addition, enabling devices that generate sensitive data to store sensitive data on systems configured for data storage may free up resources on the generating devices, allowing the systems storing large amounts of data to be optimized for such and enjoy economies of scale. For example, a device that may generate hospital patient records, may encrypt and send the data to a system, and may maintain system resources that may have otherwise been used to store the data. Additionally, when another device attempts to query the encrypted data, the device that generated the patient records may not be tasked with searching the data and generating a response, which may also reduce system resource drain.

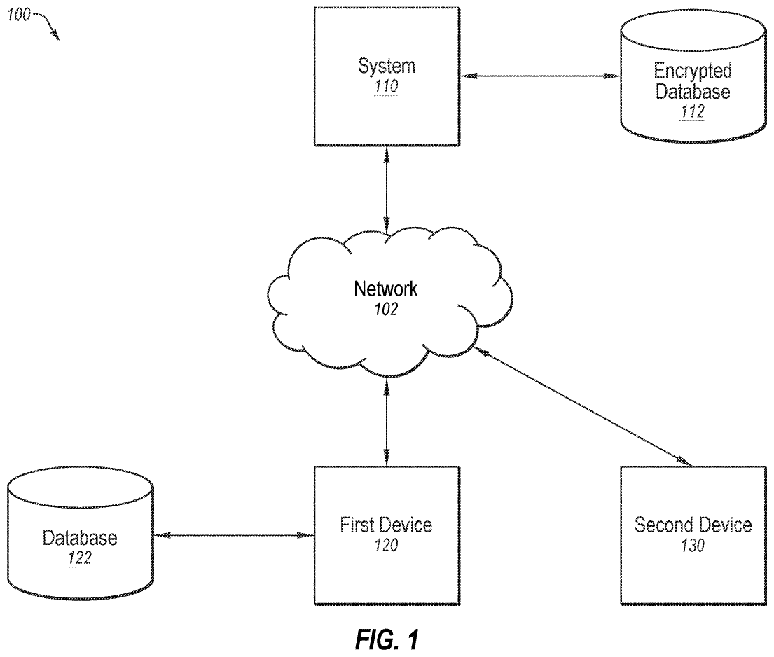

FIG. 1 illustrates an example environment 100 that includes a private searchable database, in accordance with at least one embodiment described in the present disclosure. The environment 100 may include a network 102, a storage system 110, an encrypted database 112, a first device 120, a database 122, and a second device 130.

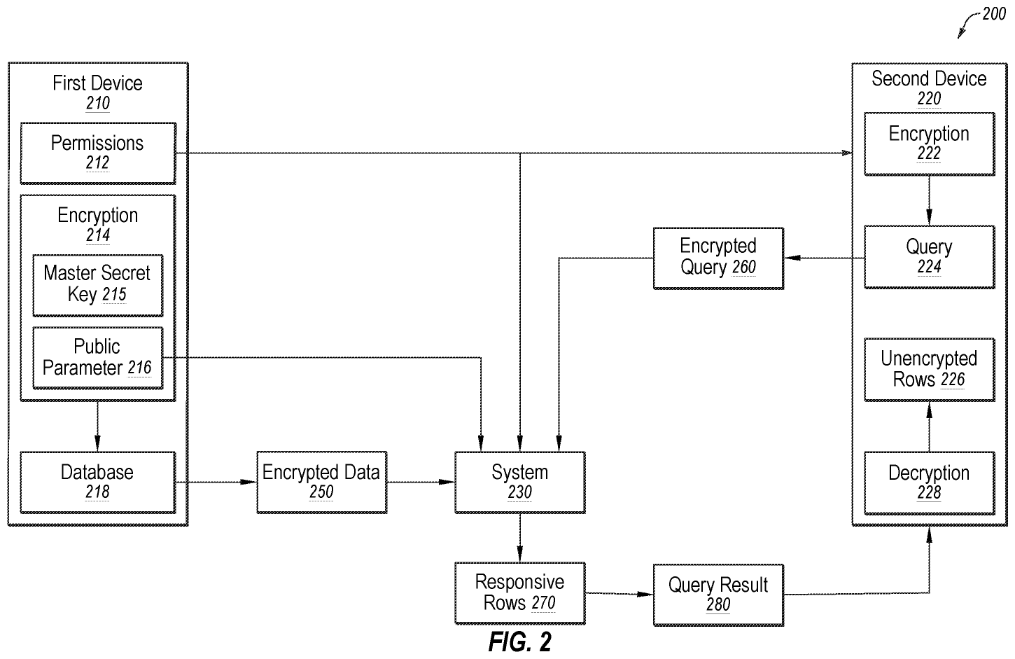

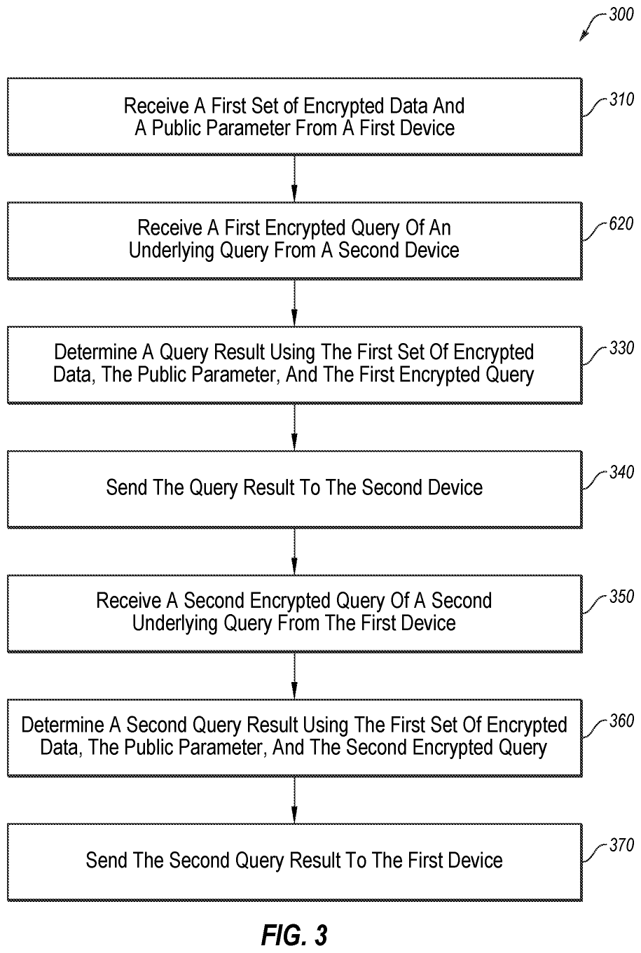

In some embodiments, the first device 120 may encrypt data and send data to the storage system 110. For example, a hospital may encrypt patient records and transmit the encrypted patient records to a storage system. Additional details regarding data encryption and transmission from the first device 120 and the storage system 110 may be found in the flow 200 of FIG. 2 and block 310 of FIG. 3.

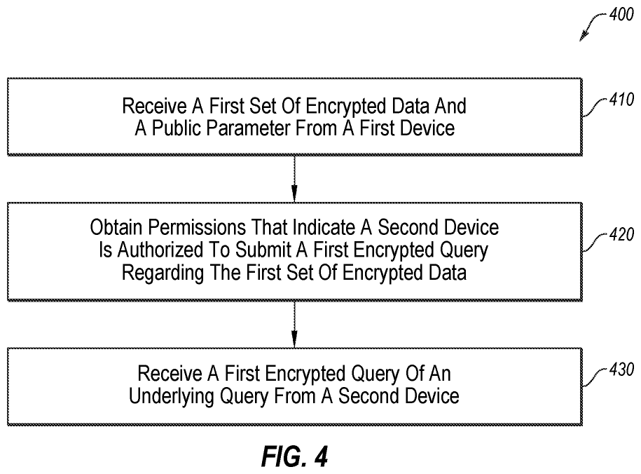

In some embodiments, the second device 130 may be permitted to request encrypted data from the storage system 110 using an encrypted query. For example, a research partner may be permitted to query patient records, where the query is an encrypted query. In some embodiments, it may be desired to keep the underlying query undisclosed to the storage system 110. In some embodiments, the second device 130 may be provided a key used to encrypt the query prior to sending the query to the storage system 110. The storage system 110 may determine responsive rows of the encrypted data to the encrypted query without decrypting the data. Additional details regarding permissions for devices and encrypted queries may be found in the method 400 of FIG. 4.

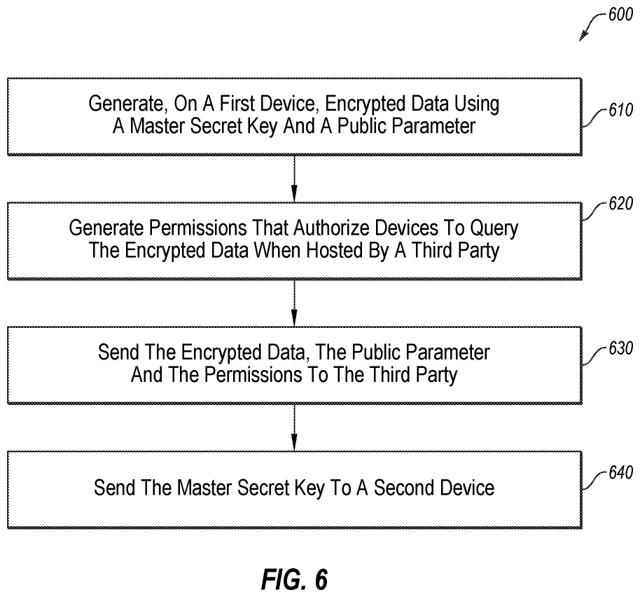

In some embodiments, the first device 120 may also submit an encrypted query to the storage system 110. For example, an administrator at a hospital may request patient information from the storage system 110. Alternatively or additionally, the first device 120 may send permissions to the storage system 110, or to the second device 130. Additional details regarding permissions may be found in the method 400 of FIG. 4 or the method 600 of FIG. 6.

The network 102 may be configured to communicatively couple the storage system 110, the first device 120, and the second device 130. In some embodiments, the network 102 may be any network or configuration of networks configured to send and receive communications between systems. In some embodiments, the network 102 may include a wired network, an optical network, and/or a wireless network, and may include numerous different configurations, including multiple different types of networks, network connections, and protocols to communicatively couple systems in the environment 100.

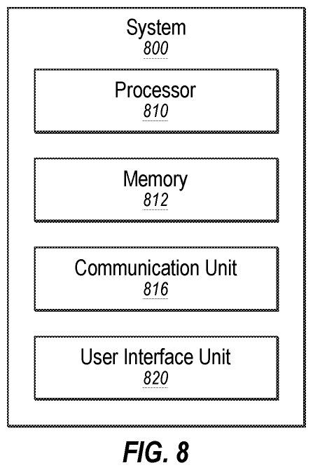

Each of the storage system 110, the first device 120, and the second device 130 may be any electronic or digital computing device and/or system. For example, each of the storage system 110, the first device 120, and the second device 130 may include a desktop computer, a laptop computer, a smartphone, a mobile phone, a tablet computer, server, a processing system, or any other computing device that may be used for performing the operations described in this disclosure and for communicating data between the storage system 110, the first device 120, and the second device 130. Examples of such computing devices may be described with reference to FIG. 8.

In some embodiments, the storage system 110 and the encrypted database 112 may be communicatively coupled to allow data to be passed between the storage system 110 and the encrypted database 112. In some embodiments, the data passed between the storage system 110 and the encrypted database 112 may be encrypted data. The encrypted database 112 may be configured to send encrypted data to the storage system 110 when requested by the storage system 110. In these and other embodiments, the storage system 110 may request data from the encrypted database 112 using an encrypted query. In some embodiments, the encrypted database 112 may be configured to receive and store encrypted data sent from the storage system 110.

In some embodiments, the communication link between the storage system 110 and the encrypted database 112 may be any configuration of networking elements configured to send and receive communications between the storage system 110 and the encrypted database 112. In these and other embodiments, data may be passed between the storage system 110 and the encrypted database 112 using methods common in digital data transfer. Such systems and/or methods may include PCI, PCI Express, Ethernet, wireless transfer such as Bluetooth®, Wi-Fi, WiMAX, cellular communications, and the like.

The encrypted database 112 may be configured to store encrypted data. The encrypted database 112 may also be configured to be searchable upon receiving a query from the storage system 110. In these and other embodiments, the query from the storage system 110 may include an encrypted query. The encrypted database 112 may include computer-readable storage media such as Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store data or data structures which may be accessed by a general-purpose or special-purpose computer.

In some embodiments, data may be a collection of information. The data may include characteristics associated with it, such as type, format, size, etc. For example, a first employee at a business may include associated employee data including a job title, a pay grade, and years of experience. In some circumstances, data may be combined and arranged in a database, corresponding to other data that has similar characteristics. Continuing the example, additional employees at the business may include similar data to the first employee, including job title, pay grade, and years of experience, each exclusive to an individual employee. The data from all the employees may be combined into an employee database, containing the job titles, pay grades, and years of experience for each employee.

In some embodiments, a database may be organized in rows. Continuing the example, the employee database may be arranged such that a first employee including job title, pay grade, and years of experience, may occupy the first row of the employee database. The second employee including job title, pay grade, and years of experience, may occupy the second row of the employee database, and so forth. In some embodiments, a database may be searchable for specific instances or groupings of data. Continuing the example, the employee database may be searched for all employees with more than ten years of experience. Alternatively or additionally, the employee database may be searched for the second employee by name.

Modifications, additions, or omissions may be made to the environment 100 without departing from the scope of the present disclosure. For example, in some embodiments, the environment 100 may not include the second device 130. In some embodiments, the second device 130 may include a database to which it is configured to communicate. Alternatively or additionally, the database 122 may be an encrypted database. Alternatively or additionally, the two devices illustrated and described are merely given as an example number of devices and is not meant to be limiting.

FIG. 2 illustrates an example operational flow 200 associated with a private searchable database, according to at least one embodiment of the present disclosure. The operational flow 200 may illustrate an operational flow for a private searchable database. For example, the operational flow 200 may illustrate sending encrypted data 250 to a storage system 230 from a first device 210, sending an encrypted query 260 from a second device 220 to the storage system 230, and receiving encrypted query results 280 at the second device 220 from the storage system 230.

In operation, a first device 210 may include a database 218 that contains private or sensitive data. The first device 210 may utilize an encryption scheme 214 for the data in the database 218 to generate encrypted data 250. The first device 210 may include permissions 212 that authorize other devices to search the encrypted data 250. As part of its operation, the encryption scheme 214 may generate a master secret key 215 and an associated public parameter 216. The first device may send the permissions 212, the associated public parameter 216, and/or the encrypted data 250 to a storage system 230. The first device 210 may send the permissions 212, and the master secret key 215 to a second device 220. The second device 220 may desire to query the encrypted data 250 and may generate a query 224. The second device 220 may use the master secret key 215 in an encryption scheme 222 to generate an encrypted query 260 using the query 224. The second device 220 may send the encrypted query 260 to the storage system 230. The storage system 230 may verify the permissions 212 and may determine that the second device 220 is authorized to submit a query in relation to the encrypted data 250. The system may use the associated public parameter 216 and the encrypted query 260 to determine responsive rows 270. The storage system 230 may combine the responsive rows into a query result 280 and may send the query result 280 to the second device 220. The second device 220 may use the master secret key 215 in a decryption scheme 228 to decrypt the query result 280 into unencrypted rows 226. The unencrypted rows 226 may be responsive to the query 224.

The first device 210 may include any general purpose or special purpose computing device. For example, the first device 210 may be analogous to the first device 120 of FIG. 1. The first device 210 may include permissions 212. The permissions 212 may be communicated to the storage system 230. Alternatively or additionally, the permissions 212 may be communicated to the second device 220. The permissions 212 may authorized specific devices, including the second device 220, that the specific devices may be permitted to query the encrypted data 250.

In some embodiments, the first device 210 may include a database 218 that may follow an organized arrangement, such as storing data in rows. In some embodiments, the database 218 may store sensitive or confidential data. For example, a hospital may include a database 218 of patient records.

In some embodiments, the first device 210 may include an encryption scheme 214. The encryption scheme 214 may be a process used to encrypt data. In some embodiments, the encryption scheme 214 may use an inner product function-private functional encryption scheme. Such an encryption scheme may permit the performance of certain functions using encrypted inputs on encrypted data. In some embodiments, the encryption scheme 214 may include a master secret key 215. Alternatively or additionally, the encryption scheme 214 may include an associated public parameter 216. The master secret key 215 and the associated public parameter 216 may be used in the encryption and decryption of data that is desired to be concealed. In some embodiments, the encryption scheme 214 may include multiple steps to encrypt data. For example, the encryption scheme 214 may implement a setup algorithm, a key generator algorithm, and an encryption algorithm.

By way of example, running a setup algorithm may generate a master secret key 215 and an associated public parameter 216 such as an associated public key. Setup may include sampling an asymmetric bilinear group ( [symbol] ₁, [symbol] ₂, [symbol] _{T}, q, e) and choosing generators g1∈ [symbol] ₁ and g2∈ [symbol] ₂, where e may represent a bilinear pairing operation e: ( [symbol] ₁× [symbol] ₂→ [symbol] _{T}, which may take one input from additive group [symbol] ₁ and one input from additive group [symbol] ₂ and may output an element from the multiplicative group [symbol] _{T}, and q may be the number of elements in [symbol] ₁, [symbol] ₂ and [symbol] _{T}. The setup algorithm may sample B← [symbol] [symbol] ₙ( [symbol] _{q}) and set B*=det(B)·(B⁻¹)^{T}. [symbol] [symbol] ₙ( [symbol] _{q}) may be a general linear group of degree n over [symbol] _{q}, which may include a set of n×n invertible matrices where individual elements of the matrices are elements of [symbol] _{q}={0, 1, . . . , q−1}. The setup algorithm may also include outputting the associated public parameter 216 as pp (where pp=( [symbol] ₁, [symbol] ₂, [symbol] _{T}, q, e)) and the master secret key 215 as msk (where msk=(pp, g1, g2, B, B*)). A key generator algorithm may take the form KeyGen(msk, x), where msk is the master secret key and x may be a vector. The key generator algorithm may include accepting the master secret key 215, from the setup algorithm, as an input, and the vector x∈ [symbol] _{q}ⁿ. The key generator algorithm may choose a uniformly random element α^{R}← [symbol] _{q} and may output the pair sk=g₁^{α·x·B}. An encryption algorithm may take the form Encrypt(msk, y), where msk is the master secret key and y may be a vector. The encryption algorithm may be used with data from the database 218 (represented as y) to generate the encrypted data 250. Alternatively or additionally, the encryption algorithm may be used with the query 224 (represented as y) to generate the encrypted query 260. The encryption algorithm may include accepting the master secret key 215, from the setup algorithm, as an input and the vector y∈ [symbol] _{q}ⁿ. The encryption algorithm may choose a uniformly random element β^{R}← [symbol] _{q} and may output the pair ct=g₂^{β·y·B}*.

In some embodiments, the encryption scheme used in the operational flow 200, such as encryption 214, may include a simplified computational cost. For example, the dominant operational cost of an inner product function-private functional encryption scheme may include a constant number, such as the number of bilinear pairings, as described above.

The encrypted data 250 may be the result of the database 218 being encrypted by the encryption scheme 214. In some embodiments, the encrypted data 250 may be organized in rows. In some embodiments, it may be desired to keep data in the database 218 private. In some embodiments, the first device 210 may apply the encryption scheme 214 to data from the database 218 prior to sending the data as the encrypted data 250 to be stored by the storage system 230.

In some embodiments, the storage system 230 may not be able to determine, access, or otherwise view the underlying data, such as the database 218, of the encrypted data 250, which may be due to the encryption by the encryption scheme 214. Alternatively or additionally, the storage system 230 may be able to determine the indices of the rows of the encrypted data 250, such that the storage system 230 may determine responsive rows to future queries, as described hereinafter.

The storage system 230 may include any general purpose or special purpose computing device. For example, the storage system 230 may be analogous to the storage system 110 of FIG. 1. In some embodiments, the storage system 230 may be a cloud-based server. For example, the storage system 230 may be a cloud-based computing system such as MICROSOFT AZURE, GOOGLE CLOUD PLATFORM, or AMAZON AWS.

The second device 220 may include any general purpose or special purpose computing device. For example, the second device 220 may be analogous to the second device 130 of FIG. 1. The second device may include the encryption scheme 222. For example, the encryption scheme 222 may be analogous to the encryption scheme 214 of the first device 210. In some embodiments, the encryption scheme 222 may receive and utilize the master secret key 215 from the encryption scheme 214.

In some embodiments, the second device 220 may include a query 224. The query 224 may be used to request data from a database. In some embodiments, the query 224 may be a plain text query requesting data from a database. For example, a user may submit a plain text query via the second device 220 to access the encrypted data associated with the first device 210 and stored by the storage system 230. In some embodiments, the encryption scheme 222 may use the master secret key 215 sent from the first device 210 to be used with the query 224 to generate an encrypted query 260.

The encrypted query 260 may be the result of the underlying query 224 being encrypted by the encryption scheme 222. In some embodiments, the storage system 230 may verify the second device 220 is permitted to request data and/or rows of the encrypted data 250, such as verifying the permissions 212 presented from the second device 220 to the permissions 212 that may have been provided from the first device 210. In instances in which the second device 220 does not have permission to request and/or access the encrypted data 250, the storage system 230 may restrict sharing data and/or rows of the encrypted data 250 with the second device 220. In some embodiments, the storage system 230 may utilize an encrypted query 260 encrypted according to the encryption algorithm described above to perform a query of the encrypted data stored by the storage system 230. For example, the data stored by the storage system 230 may be encrypted according to the encryption algorithm described above such that the storage system 230 is unable to directly query or otherwise observe the data it is storing.

By way of example, encrypting the query 224 may start by obtaining a query string, which may be represented mathematically by s∈( [symbol] _{q}∪{*})ⁿ⁻¹, where [symbol] _{q}∪{*} may include a set of positive integers less than q (which may include 0) along with the special symbol {*} and s may be a string of length n−1. The encryption algorithm may set y=0ⁿ∈ [symbol] _{q}ⁿ and may set Δ=0. The encryption algorithm may iterate over i∈[1, n−1] and if sᵢ≠*, the encryption algorithm may sample a random integer r← [symbol] _{q}. The encryption algorithm may set yᵢ=r, and the encryption algorithm may perform the function Δ+=sᵢ*yᵢ. The encryption algorithm may set yₙ=−Δ, and evaluate c_{qs}=Encrypt(msk, y) where Encrypt(msk, y) is the encryption algorithm described above, and c_{qs} is the encrypted query 260.

The responsive rows 270 may be determined by the storage system 230. The responsive rows 270 may include rows of the encrypted data 250. The responsive rows 270 may remain encrypted and unexposed to the storage system 230, for example, such that the storage system 230 may not determine any underlying content of the encrypted data 250 other than the indices related to the rows of the encrypted data 250. In some embodiments, only the indices of the responsive rows may be visible to the storage system 230. In some embodiments, the responsive rows 270 may be a result of the storage system 230 using the encrypted query 260 and the associated public parameter 216 to query the encrypted data 250. Alternatively or additionally, the storage system 230 may use the encrypted query 260 and the associated public parameter 216 to check whether an individual row of the encrypted data 250 is a responsive row 270.

For example, the storage system 230 may input the encrypted query 260, the associated public parameter 216, and a first row of the encrypted data 250 into a decryption function. Continuing the example, if the result of the decryption returns true, the first row of the encrypted data 250 may be included in the responsive rows 270. Continuing the example, the storage system 230 may iterate through all the rows of the encrypted data 250 as inputs into the decryption function. In these and other embodiments, the responsive rows may be sent as the query result 280 to the second device 220. For example, for each row identified as responsive, the row may be appended to the query result 280.

By way of example, the storage system 230 may receive the encrypted database 250, represented as (ctᵥ_{₁}, ctᵥ_{₂}, . . . , ctᵥ_{ₘ}), and the associated public parameter, represented as pp. Upon receiving an encrypted query 260, represented as c_{qs}, the storage system 230 may generate a set of one or more responsive rows 270, ResponsiveRow={ }, the set of which may initially be empty. The storage system 230 may iterate over the set i∈[1, m] and set (ctᵥ_{ᵢ}_{,1}, ctᵥ_{ᵢ}_{,2})=ctᵥ_{ᵢ}. The storage system 230 may evaluate Decrypt(pp, ctᵥ_{ᵢ}_{,1}, c_{qs}), where Decrypt is the decryption algorithm described above. If the results of the decrypt algorithm returns True, the storage system 230 may append the result to the set of responsive rows 270, where ResponsiveRow=ResponsiveRow∪{ctᵥ_{ᵢ}_{,2}}. Upon iterating over the set m, the completed set ResponsiveRow may be returned as the query result 280 to the second device 220.

The query result 280 may be the aggregation of the responsive rows 270, as determined by the storage system 230. In some embodiments, each newly determined responsive row 270 may be appended to an existing responsive row 270 for an encrypted query 260. Alternatively or additionally, the result of all the responsive rows 270 may become the query result 280. For example, if set of encrypted data 250 includes ten rows and is queried by the encrypted query 260, the storage system 230 may determine that the first row of the set of encrypted data 250 is a responsive row 270. Continuing the example, the storage system 230 may determine that the third row of the encrypted data 250 is also a responsive row 270 to the encrypted query 260 and may append the third row to the first row. Continuing the example, the storage system 230 may determine that the sixth row of the encrypted data 250 is also a responsive row 270 to the encrypted query 260 and may append the sixth row to the first and third rows. Continuing the example, the storage system 230 may set the first, third, and sixth rows of the encrypted data 250 as the query result 280 and send the query result 280 to the device that originated the encrypted query 260. In some embodiments, the query result 280 may be sent to the second device 220. Alternatively or additionally, the query result 280 may be sent to the device that originated an encrypted query 260.

In some embodiments, the second device 220 may include the decryption scheme 228. The decryption scheme 228 may be used to decrypt data that was previously encrypted. For example, plain text data that had previously been encrypted may be retrieved or obtained with the decryption scheme 228. In some embodiments, the decryption scheme 228 may use the master secret key 215 when decrypting data. For example, the second device 220 may use the master secret key 215 in the decryption scheme 228 to covert encrypted data into plain text data.

In some embodiments, the second device 220 may obtain unencrypted rows 226 as the result of the decryption scheme 228 decrypting encrypted rows of the query result 280. In some embodiments, the unencrypted rows 226 may be in plain text. In some embodiments, the unencrypted rows 226 may include data that is responsive to the query 224.

By way of example, the second device 220 may receive a query result 280 from the storage system 230, which query result 280 may be encrypted and may be structured as

$$\{ c {t}_{{v}_{{i}_{1}} , 2} , {ct}_{{v}_{{i}_{2}} , 2} , … , {ct}_{{v}_{{i}_{k}} , 2} \} .$$

A decryption algorithm may take the form Decrypt(pp, sk, ct), where pp represents an associated public parameter, sk represents a secret key, and ct represents an element to be decrypted. The decryption scheme 228 may iterate over the set j∈[1, k], applying the decryption algorithm

$${v}_{{i}_{j}} = Decrypt ( pp , s {k}_{aes} , {ct}_{{v}_{{i}_{j}} , 2} ) ,$$

where pp is the associated public parameter, skₐₑₛ is a secret key sampled from the master secret key, and

$$c {t}_{{v}_{{i}_{j}} , 2}$$

is an element of the query result 280. The decryption algorithm

$$Decrypt ( pp , {sk}_{a e s} , {ct}_{{v}_{{i}_{j}} , 2} ) computes D = e ( s {k}_{a e s} , {ct}_{{v}_{{i}_{j}} , 2} )$$

and checks whether D is the identity element in a target group.

Modifications, additions, or omissions may be made to the operational flow 200 without departing from the scope of the present disclosure. For example, both the first device 210 and the second device 220 may transmit encrypted data 250 to the storage system 230. The storage system 230 may store each unique set of encrypted data 250 in a unique database. As another example, both the first device 210 and the second device 220 may submit an encrypted query 260 to the storage system 230. As another example, the first device 210 may utilize a decryption scheme 228 for decrypting a query result 280 in response to the first device 210 submitting an encrypted query 260 to the storage system 230.

FIG. 3 illustrates a flowchart of an example method 300 of a private searchable database with multiple queries. The method 300 may be arranged in accordance with at least one embodiment described in the present disclosure. One or more operations of the method 300 may be performed, in some embodiments, by a device or system, such as the storage system 110, the first device 120, and/or the second device 130 of FIG. 1, the first device 210, the second device 220, and/or the storage system 230 of FIG. 2, and/or the system 800 of FIG. 8, or another device, combination of devices, or systems. In these and other embodiments, the method 300 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 300 may begin at block 310 where a first set of encrypted data and an associated public parameter may be received. For example, a system (such as the storage system 110 of FIG. 1 and/or the storage system 230 of FIG. 2) may receive the first set of encrypted data and the associated public parameter from a first device (such as the first device 120 of FIG. 1 and/or the first device 210 of FIG. 2). In some embodiments, the system may receive a first permission with the first set of encrypted data that the system may use to verify a device is permitted to access the first set of encrypted data. After receiving the encrypted data, the system may store the first set of encrypted data in an encrypted database (such as the encrypted databased 112 of FIG. 1). In some embodiments, the first set of encrypted data may be data from a database that has been encrypted with an inner product function-private functional encryption scheme. The associated public parameter may be an output from running the setup of the encryption scheme. For example, the associated public parameter may be an asymmetric bilinear group, as described in relation to the associated public parameter 216 of FIG. 2. In some embodiments, the first set of encrypted data may be organized in rows.

At block 320, the system may receive a first encrypted query of a first underlying query from a second device. For example, the first underlying query may be a plain text request for data from the database. In some embodiments, the system may verify the second device is permitted to request data from the first set of encrypted data. For example, the second device may send a second permission that the system may use to compare to the first permission sent from the first device. In instances in which the first permission and the second permission do not match, the system may not respond to the first encrypted query from the second device. The first encrypted query may be encrypted using the same or substantially similar encryption scheme that was used to encrypt the data sent to the system from the first device. For example, the first encrypted query may be encrypted using an inner product function-private functional encryption scheme. In some embodiments, the second device may receive permission from the first device to submit a query to the system.

At block 330, the system may determine a first query result in response to the first encrypted query. The system may use the first set of encrypted data, the associated public parameter, and the first encrypted query to determine the first query result. For example, the system may compute an inner product on the iterative elements of the first set of encrypted data and the first encrypted query, in conjunction with the associated public parameter. Continuing the example, if the result of the inner product is zero, the element of the first set of encrypted data (e.g., the first row) is considered responsive to the query and is included with the query result. In some embodiments, the first query result may remain encrypted and unexposed to the system. Alternatively or additionally, the system may only learn the indices of the rows of the first set of encrypted data that is included in the first query result. For example, a first set of encrypted data may include three rows of encrypted data. In response to receiving a first encrypted query, a system may determine that the second row is the query result. Continuing the example, the system may learn that the query result is the second row of the first set of encrypted data and may not gain access to the unencrypted contents of the second row of the first set of encrypted data.

At block 340, the system may send the first query result to the second device. In some embodiments, the first query result may remain encrypted and unexposed to the system.

At block 350, the system may receive a second encrypted query of a second underlying query from the first device. For example, the first device that provided the encrypted data may also query the stored and encrypted database. For example, if a hospital (as the first device) were to store a patient database as an encrypted database on a cloud-based system (the system), the hospital (the first device) may query the encrypted database in addition to a research partner (the second device) being able to query the encrypted database.

At block 360, the system may determine a second query result in response to the second encrypted query. The system may use the first set of encrypted data, the associated public parameter, and the second encrypted query to determine the second query result. In some embodiments, the system may use the same or similar operation, described at block 330, to determine the second query result as was used to determine the first query result, with the exception of using the second encrypted query in place of the first encrypted query.

At block 370, the system may send the second query result to the first device. In some embodiments, the second query result may remain encrypted and unexposed to the system.

Modifications, additions, or omissions may be made to FIG. 3 without departing from the scope of the present disclosure. For example, the functions and/or operations performed may be implemented in differing order, or may be combined into fewer functions and operations, or expanded into additional functions and operations without detracting from the essence of the disclosed embodiments. For example, the method 300 may include more or fewer elements than those illustrated and described in the present disclosure. For example, permissions may be received and authenticated in conjunction with receiving a first encrypted query from a second device to ensure the second device is permitted to access the encrypted data. In addition, permissions may be received and authenticated in conjunction with receiving a second encrypted query from a first device to ensure the first device is permitted to access the encrypted data. In some embodiments, a system may receive multiple sets of encrypted data. In addition, each received set of encrypted data may be stored in a unique database, separate from other sets of encrypted data.

FIG. 4 illustrates a flowchart of an example method 400 of limiting queries to devices with permissions. The method 400 may be arranged in accordance with at least one embodiment described in the present disclosure. One or more operations of the method 400 may be performed, in some embodiments, by a device or system, such as the storage system 110, the first device 120, and/or the second device 130 of FIG. 1, the first device 210, the second device 220, and/or the storage system 230 of FIG. 2, and/or the system 800 of FIG. 8, or another device, combination of devices, or systems. In these and other embodiments, the method 400 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 400 may begin at block 410 where a system may receive a first set of encrypted data from a first device. The block 410 may be similar or comparable to the block 310 of FIG. 3.

At block 420, the system may obtain permissions. In some embodiments, the permissions may be received from the first device. The permissions may indicate a second device is authorized to submit a first encrypted query regarding the first set of encrypted data. In some embodiments, the permissions may be received from the second device in conjunction with a query from the second device.

At block 430, the system may receive a first encrypted query. The first encrypted query may be an encrypted query of an underlying query from a second device. In some embodiments, the underlying query may be a plain text database query. When the permissions are received from the second device, the permissions and the first encrypted query may be received together in a single message or may be sent separately.

Modifications, additions, or omissions may be made to FIG. 4 without departing from the scope of the present disclosure. For example, the method 400 may include more or fewer elements than those illustrated and described in the present disclosure. In some embodiments, a third device may not have received permissions and may not be authorized to submit a query to the system. In such a circumstance, the system may or may not respond to an encrypted query received from a third device.

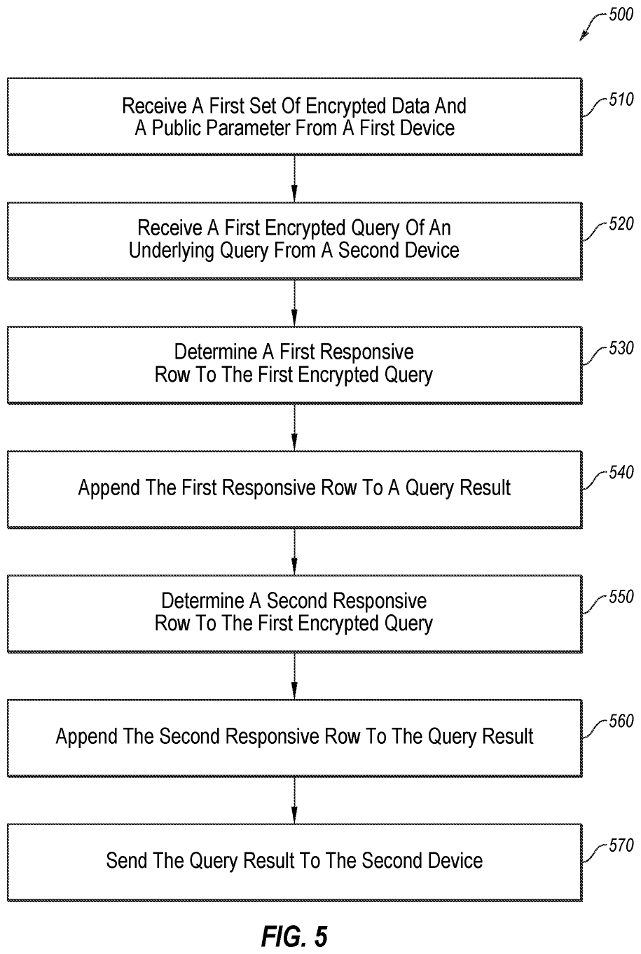

FIG. 5 illustrates a flowchart of an example method 500 of building a query result responsive to a query. The method 500 may be arranged in accordance with at least one embodiment described in the present disclosure. One or more operations of the method 500 may be performed, in some embodiments, by a device or system, such as the storage system 110, the first device 120, and/or the second device 130 of FIG. 1, the first device 210, the second device 220, and/or the storage system 230 of FIG. 2, and/or the system 800 of FIG. 8, or another device, combination of devices, or systems. In these and other embodiments, the method 500 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 500 may begin at block 510 where a system may receive a first set of encrypted data and an associated public parameter from a first device. The block 510 may be similar or comparable to the block 310 of FIG. 3.

At block 520, the system may receive a first encrypted query from a second device. The block 520 may be similar or comparable to the block 320 of FIG. 3.

At block 530, the system may determine a first responsive row to the first encrypted query. For example, the system may determine the first responsive row using a decryption algorithm. The decryption algorithm may use the associated public parameter, the first encrypted query, and the first set of encrypted data to determine the first responsive row. In some embodiments, the system may iterate through the rows of the first set of encrypted data as inputs into the decryption algorithm. In these and other embodiments, the decryption algorithm may output a binary value (e.g., True, 0, etc.) that may indicate that the row in question is the first responsive row.

At block 540, the system may append the first responsive row to a query result. In some embodiments, the query result may be empty prior to appending the first responsive row as an initial row with data that is responsive to the underlying query of the block 520.

At block 550, the system may determine a second responsive row to the first encrypted query. In some embodiments, the second responsive row (and other responsive rows) may be determined as the system continues to iterate over the rows of the first set of encrypted data, after determining the first responsive row.

At block 560, the system may append the second responsive row to the query result.

At block 570, the system may send the query result to the second device. The block 570 may be similar or comparable to the block 370. In some embodiments, the system may determine the query result is fully responsive after iterating through all the rows of the first set of encrypted data.

Modifications, additions, or omissions may be made to FIG. 5 without departing from the scope of the present disclosure. For example, the method 500 may include more or fewer elements than those illustrated and described in the present disclosure. In some embodiments, a responsive row may contain only a single element. Alternatively or additionally, the two appended responsive rows illustrated and described is merely given as an example number of responsive rows and is not meant to be limiting.

FIG. 6 illustrates a flowchart of an example method 600 of generating and distributing security measures for private data. The method 600 may be arranged in accordance with at least one embodiment described in the present disclosure. One or more operations of the method 600 may be performed, in some embodiments, by a device or system, such as the storage system 110, the first device 120, and/or the second device 130 of FIG. 1, the first device 210, the second device 220, and/or the storage system 230 of FIG. 2, and/or the system 800 of FIG. 8, or another device, combination of devices, or systems. In these and other embodiments, the method 600 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 600 may begin at block 610 where a first device may generate a first set of encrypted data. The first set of encrypted data may be generated using an encryption scheme that is an inner product function-private functional encryption scheme. In some embodiments, the data may be encrypted using a master secret key and an associated public parameter. In some embodiments, the first set of encrypted data may be organized in rows.

At block 620, the first device may generate permissions that authorize a second device to query the first set of encrypted data. In some embodiments, the permissions may authorize the second device to query the first set of encrypted data when the first set of encrypted data is hosted by a third party.

At block 630, the first device may send the first set of encrypted data, the public parameter, and the permissions to the third party. In some embodiments, the first device may send the permissions to the second device in addition to or instead of sending the permissions to the third party.

At block 640, the first device may send the master secret key to a second device. In some embodiments, the first device may send the permissions to the second device. The master secret key may be used by the second device to encrypt data using the same encryption scheme as the first device. For example, the second device may use the master secret key to encrypt a query that may be sent to the third party to query the first set of encrypted data. Alternatively or additionally, the second device may use the master secret key in a decryption scheme. For example, the second device may use the master secret key in the decryption scheme to decrypt the responsive rows the third party returns in response to the query. In some embodiments, the permissions may indicate to the third party that the second device is authorized to submit a query to the third party. Alternatively or additionally, the permissions may be sent in conjunction with an encrypted query to the third party, and the permissions may be used to verify with the third party that the second device is permitted to query the first set of encrypted data.

Modifications, additions, or omissions may be made to FIG. 6 without departing from the scope of the present disclosure. For example, the method 600 may include more or fewer elements than those illustrated and described in the present disclosure. While described in the context of a first and second device, it will be appreciated that any number of devices may be provided access to query the encrypted database hosted by the third party.

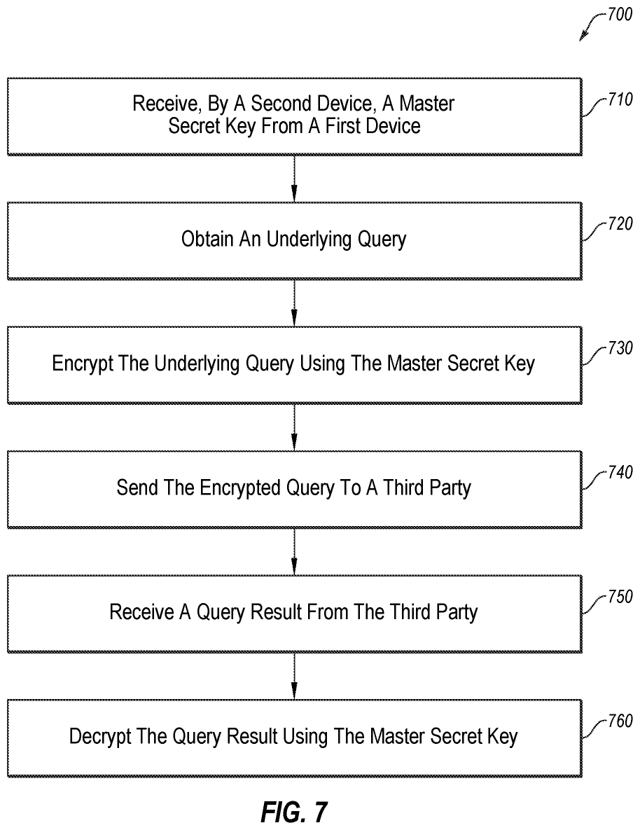

FIG. 7 illustrates a flowchart of an example method 700 of a device receiving encryption data (such as public and/or private keys) and permissions to query a private database and receive a query result. The method 700 may be arranged in accordance with at least one embodiment described in the present disclosure. One or more operations of the method 700 may be performed, in some embodiments, by a device or system, such as the storage system 110, the first device 120, and/or the second device 130 of FIG. 1, the first device 210, the second device 220, and/or the storage system 230 of FIG. 2, and/or the system 800 of FIG. 8, or another device, combination of devices, or systems. In these and other embodiments, the method 700 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 700 may begin at block 710 where a second device receives a master secret key from a first device. In some embodiments, the master secret key may be a result of an encryption scheme utilized by the first device.

At block 720, the second device may obtain an underlying query. For example, a user of the second device may input the underlying query at the second device. In some embodiments, the underlying query may be configured to request data from a database. For example, the underlying query may be a plain text database query.

At block 730, the second device may use the master secret key in an encryption scheme to encrypt the underlying query. In some embodiments, the encryption scheme may be an inner product function-private functional encryption scheme.

At block 740, the second device may send the encrypted query to a third party as a query to a database. In some embodiments, the third party may host a first set of encrypted data that may be provided and/or encrypted by another entity. The first set of encrypted data may include encrypted data from a database, organized in rows. In some embodiments, the third party may use the encrypted query to query the first set of encrypted data to determine a query result. In some embodiments, the encrypted query may remain encrypted and unexposed to the third party.

At block 750, the query result may be received from the third party by the second device. In some embodiments, the query result may be encrypted. In some embodiments, the query result may include any number of rows, or elements of rows of the first set of encrypted data.

At block 760, the second device may decrypt the query result using the master secret key. The decrypted query result may be responsive to the underlying query.

Modifications, additions, or omissions may be made to FIG. 7 without departing from the scope of the present disclosure. For example, the method 700 may include more or fewer elements than those illustrated and described in the present disclosure.

FIG. 8 is a block diagram illustrating an example computing device 800 that is arranged to be used in a private searchable database, according to at least one embodiment of the present disclosure. The system 800 may include a processor 810, memory 812, a communication unit 816, and a user interface unit 820, which all may be communicatively coupled. In some embodiments, the system 800 may be part of any of the systems or devices described in this disclosure.

For example, the system 800 may be part of the storage system 110 of FIG. 1 and may be configured to perform one or more of the tasks described above with respect to the storage system 110. As another example, the system 800 may be part of the first device 120, or the second device 130 of FIG. 1 and may be configured to perform one or more of the functions described above.

Generally, the processor 810 may include any suitable special-purpose or general-purpose computer, computing entity, or processing device including various computer hardware or software modules and may be configured to execute instructions stored on any applicable computer-readable storage media. For example, the processor 810 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 8, it is understood that the processor 810 may include any number of processors distributed across any number of networks or physical locations that are configured to perform individually or collectively any number of operations described herein. In some embodiments, the processor 810 may interpret and/or execute program instructions and/or process data stored in the memory 812. In some embodiments, the processor 810 may execute the program instructions stored in the memory 812.

For example, in some embodiments, the processor 810 may execute program instructions stored in the memory 812 that are related to a private searchable database such that the system 800 may perform or direct the performance of the operations associated therewith as directed by the instructions. In these and other embodiments, the instructions may be used to perform one or more operations of the flow 200 FIG. 2, or the methods 300 of FIG. 3, 400 of FIG. 4, 500 of FIG. 5, 600 of FIG. 6, or 700 of FIG. 7.

The memory 812 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 810.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media.

Computer-executable instructions may include, for example, instructions and data configured to cause the processor 810 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The communication unit 816 may include any component, device, system, or combination thereof that is configured to transmit or receive information over a network. In some embodiments, the communication unit 816 may communicate with other devices at other locations, the same location, or even other components within the same system. For example, the communication unit 816 may include a modem, a network card (wireless or wired), an infrared communication device, a wireless communication device (such as an antenna), and/or chipset (such as a Bluetooth® device, an 802.6 device (e.g., Metropolitan Area Network (MAN)), a WiFi device, a WiMax device, cellular communication facilities, etc.), and/or the like. The communication unit 816 may permit data to be exchanged with a network and/or any other devices or systems described in the present disclosure. For example, when the system 800 is included in the storage system 110 of FIG. 1, the communication unit 816 may allow the storage system 110 to communicate with the first device 120.

The user interface unit 820 may include any device to allow a user to interface with the system 800. For example, the user interface unit 820 may include a mouse, a track pad, a keyboard, buttons, camera, and/or a touchscreen, among other devices. The user interface unit 820 may receive input from a user and provide the input to the processor 810.

Modifications, additions, or omissions may be made to the system 800 without departing from the scope of the present disclosure. For example, in some embodiments, the system 800 may include any number of other components that may not be explicitly illustrated or described. Further, depending on certain implementations, the system 800 may not include one or more of the components illustrated and described.

As indicated above, the embodiments described herein may include the use of a special purpose or general-purpose computer (e.g., the processor 810 of FIG. 8) including various computer hardware or software modules, as discussed in greater detail below. Further, as indicated above, embodiments described herein may be implemented using computer-readable media (e.g., the memory 812 of FIG. 8) for carrying or having computer-executable instructions or data structures stored thereon.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
receiving, by a system, a first set of encrypted data and an associated public parameter from a first device, the first set of encrypted data organized in rows;
receiving a first encrypted query of an underlying query from a second device;
determining a query result using the first set of encrypted data, the associated public parameter, and the first encrypted query, the query result including responsive rows of the first set of encrypted data that remain encrypted and are responsive to the underlying query without exposing the underlying query or the first set of encrypted data to the system; and
sending the query result to the second device.

2. The method of claim 1, further comprising receiving a second encrypted query of a second underlying query from the first device.

3. The method of claim 1, wherein the system is a cloud-based server.

4. The method of claim 1, further comprising obtaining permissions by the system, the permissions including an indication that the second device is authorized to submit the first encrypted query to the system.

5. The method of claim 1, wherein the underlying query is an unencrypted, plain text, database query.

6. The method of claim 1, wherein determining the query result comprises identifying a given row of the first set of encrypted data as one of the responsive rows based on the given row being orthogonal to the first encrypted query.

7. The method of claim 6, further comprising appending additional rows that are orthogonal to the first encrypted query to the given row as the query result.

8. The method of claim 1, wherein upon determining the query result, the system learns only indices of the responsive encrypted rows.

9. The method of claim 1, further comprising sending the query result to the second device in a same encrypted state in which the system received the first set of encrypted data.

10. The method of claim 1, wherein the encryption scheme of the first set of encrypted data is an inner product function-private functional encryption scheme.

11. A non-transitory computer-readable storage medium having computer-executable instructions stored thereon that are executable by a processor device to perform or control performance of operations comprising:
receiving, by a system, a first set of encrypted data and an associated public parameter from a first device, the first set of encrypted data organized in rows;
receiving a first encrypted query of an underlying query from a second device;
determining a query result using the first set of encrypted data, the associated public parameter, and the first encrypted query, the query result including responsive rows of the first set of encrypted data that remain encrypted and are responsive to the underlying query without exposing the underlying query or the first set of encrypted data to the system; and
sending the query result to the second device.

12. The non-transitory computer-readable storage medium of claim 11, further comprising receiving a second encrypted query of a second underlying query from the first device.

13. The non-transitory computer-readable storage medium of claim 11, wherein the system is a cloud-based server.

14. The non-transitory computer-readable storage medium of claim 11, further comprising obtaining permissions by the system, the permissions including an indication that the second device is authorized to submit the first encrypted query to the system.

15. The non-transitory computer-readable storage medium of claim 11, wherein the underlying query is an unencrypted, plain text, database query.

16. The non-transitory computer-readable storage medium of claim 11, wherein determining the query result comprises identifying a given row of the first set of encrypted data as one of the responsive rows based on the given row being orthogonal to the first encrypted query.

17. The non-transitory computer-readable storage medium of claim 16, further comprising appending additional rows that are orthogonal to the first encrypted query to the given row as the query result.

18. The non-transitory computer-readable storage medium of claim 11, wherein upon determining the query result, the system learns only indices of the responsive encrypted rows.

19. The non-transitory computer-readable storage medium of claim 11, further comprising sending the query result to the second device in a same encrypted state in which the system received the first set of encrypted data.

20. The non-transitory computer-readable storage medium of claim 11, wherein the encryption scheme of the first set of encrypted data is an inner product function-private functional encryption scheme.
